(19) United States
(12) Patent Application Publication
(10) Pub. No.: US 2006/0232106 A1
(43) Pub. Date: Oct. 19, 2006

(54) Unit area in a motor vehicle

(76) Inventor: Alfons Haas, Stuttgart (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/530,764

(22) PCT Filed: Sep. 18, 2003
(86) PCT No.: PCT/EP03/10391

§ 371 Date: Feb. 8, 2006

(30) Foreign Application Priority Data
Oct. 16, 2002 (DE) 10248188.1

(51) Int. Cl. B60R 27/00

(52) U.S. Cl. 296/208

(57) ABSTRACT

The invention relates to an assembly space in a motor vehicle for the reception of operating assemblies, which is mounted in front of a dashboard separating a passenger space from an engine space capable of being covered by means of a hood and which is closed all round with the exception of an access orifice pointing towards the hood. To achieve a cost-saving and space-saving integration of an air supply device, normally arranged separately in the engine space, for an air consumer arranged in the passenger space into the assembly space, the assembly space has produced in it a gastight incoming air connection to an air inlet orifice arranged in the hood, a water separator is integrated and a waste air orifice is arranged in such a way that it is approximately congruent with the intake orifice of the air consumer in the dashboard.

### BACKGROUND AND SUMMARY OF THE INVENTION

The invention relates to an assembly space in a motor vehicle for the reception of operating assemblies.

A known assembly space (DE 26 41 444 C2) is delimited rearwardly via the dashboard separating the passenger space from the engine space and forwardly by a partition running transversely in the engine space. The assembly space is closed off all round by means of a further two longitudinal walls and a bottom. The assembly space has only one access opening, facing the hood, for access to the assembly accommodated in the assembly space, this access opening being exposed after the opening of the hood. On the front edge facing the hood, the assembly space carries a continuous seal which surrounds the access opening. When the hood is being closed, a lower shell fastened to the underside of the hood is pressed on the continuous seal and thus closes off the assembly space in a gastight manner with respect to the engine space. In the shell bottom, an air passage opening is arranged in a bottom region which lies within the continuous seal. In a shell wall region facing the windshield of the motor vehicle, an air inlet opening is introduced, via which the lower shell is connected to a retaining space into which air flows through a wide gap between the trailing edge of the hood and the windshield. The retained air penetrating via the air inlet opening and air passage opening in the lower shell into the assembly space flows through the assembly space to ventilate the assemblies arranged here, and flows out again into the surroundings via at least one waste air opening. The waste air opening issues in a longitudinal joint of the hood and is arranged at a point on the hood at which high underpressure occurs. By contrast, the air inlet opening is provided where the relative wind builds up, so that air introduced into the assembly space by means of overpressure is sucked away again at the waste air opening by means of underpressure. The air inlet opening is in this case arranged in the vicinity of a fresh air inlet for the passenger space, via which inlet fresh air is sucked in by a blower, for example, of an air conditioning system. In order to prevent secondary air from being sucked in from the assembly space by the blower via the fresh air inlet, a nonreturn flap in the lower shell is provided, which, with the ventilation blower fully switched on, automatically closes the air inlet opening in the lower shell.

In a known air supply device for an air consumer in the passenger space, for example for a blower for ventilating the passenger space (DE 197 34 146 A1), there is a housing well between an air inlet opening arranged in the hood and a dashboard opening which is arranged in the dashboard and to which the intake opening of the air consumer or of the blower is connected. The housing well is sealed off relative to the hood by means of a seal surrounding the air inlet opening in the hood and relative to the dashboard by means of a seal surrounding the dashboard opening. A water separator is arranged in the housing well, and a water outflow for the water separated from the air is provided at the lowest point of the well bottom. The water separator is designed as a bulkhead, at which the air flowing into the housing well is deflected through about 90°. In this case, the water drops present in the form of a mist in the air are precipitated on the bulkhead and drop down to the well bottom.

In a known assembly space (DE-C-198 11 189), the water separator is formed by a filter housing which is arranged below the access opening and of which the housing opening surrounding an air filter points downward, that is to say away from the access opening. The outlet of the filter housing is placed congruently on a wall opening in the dashboard separating off the passenger space. That region of the filter housing which faces the access opening runs, in the installation position, obliquely downward in a direction pointing away from the dashboard and is provided at the end with a water collecting channel which guides the water dropping in from outside through the access opening past the filter housing laterally. The filter in the inlet of the filter housing is consequently not wetted by the water running out.

In a vehicle with a front window and windshield wiper (FR-A-2 623 455), it is known, by means of a [lacuna] in an assembly space which receives the windshield wiper motor and the windshield wiper mechanism and which is sealed off relative to the engine space, to provide a drip molding underneath the front window for discharging the water running off on the front window. The molding wall, facing away from the front window, of the drip molding is drawn up as far as the hood and possesses an opening, via which air can flow into the assembly space and from there to an opening in the dashboard separating off the passenger space. The molding wall having the opening is prolonged downward beyond the molding bottom and forms a water separator. By means of this water separator, the air flowing into the assembly space is deflected through more than 90° before it can arrive at the dashboard opening.

The object on which the invention is based is to combine more cost-effectively in structural terms an assembly space of the type initially mentioned with an air supply for the supply of fresh air to an air consumer arranged in the passenger space, for example to a ventilation blower for the passenger space or to a blower of an air conditioning system.

The object is achieved, according to the invention, by the assembly spaces described and claimed below.

The assembly space according to the invention has the advantage of a combination, cost-effective with regard to the manufacturing costs, of the fresh air supply to the passenger space and of an easily accessible reception box for various operating assemblies and components, around which fresh air flows. The operating assemblies and components may include a battery, lines and a servomotor and windshield wiper motor. By virtue of the combination, a separate air supply device, such as provided in DE 197 34 146 A1, becomes unnecessary, so that the installation space to be reserved in the engine space is also reduced to a considerable extent. The assembly space according to the invention, because of its very low construction space requirement, is particularly suitable for vehicles of the compact class. The water separator formed on the lower shell ensures a very good dehumidification of the air entering the passenger space or supplied to the air conditioning system. Preferably, the lower shell is fastened to the underside of the hood and consists of sheet metal, although it is possible for the hood inner panel to be formed as a lower shell in the region of the assembly space, so that no additional component is necessary for the lower shell. Overall, the incoming air connection between the air inlet orifice in the hood and the assembly space with water separator can be configured optimally with regard to the manufacturing costs and to the installation space.

According to an advantageous embodiment of the invention, a lower shell is provided which covers the air inlet opening in the hood and is sealed off relative to the hood. The lower shell can be placed onto the continuous seal surrounding the access opening and, within its region surrounded by the continuous seal, has an air passage opening. Preferably, the lower shell is fastened to the underside of the hood and consists of sheet metal, although it is possible for the hood inner panel to be formed as a lower shell in the region of the assembly space, so that no additional component is necessary for the lower shell. By virtue of these structural measures, the incoming air connection between the air inlet opening in the hood and the assembly space with a water separator can be configured optimally with regard to the manufacturing costs and to the installation space required.

According to an advantageous embodiment of the invention, between the access opening and the lower shell is arranged a collar-shaped cover having a peripheral flange continuing at one collar edge. The cover lies with its flange on the continuous seal and, on its front edge remote from the flange, carries a shell seal onto which the lower shell can be pressed. Such a configuration is advantageous when the clear cross section of the air inlet opening in the hood is substantially smaller than the required access opening to the assembly space. The size of the lower shell is determined by the clear cross section of the air inlet opening in the hood, and the cover adapts the smaller lower shell to the size of the access opening of the assembly space. As a result, the assembly space receives only air via the air inlet opening in the hood and the penetration of secondary air from the engine space is reliably prevented.

If the air inlet opening in the hood lies directly above the assembly space, so that the said air inlet opening is surrounded by the access opening of the assembly space, then, according to an advantageous embodiment of the invention, the lower shell is dispensed with and the access opening is sealed off by a cover directly on the inside of the hood. For this purpose, a cover is provided which covers the air inlet opening in the hood and which lies on the continuous seal and can be sealed off relative to the hood by means of a continuous hood seal surrounding the air inlet opening. The cover, within its region surrounded by the continuous seal, has an air passage opening and a water separator.

According to an advantageous embodiment of the invention, a lower shell covers the air inlet opening in the hood and is sealed off relative to the hood. A cover can be sealed off relative to the lower shell by a shell seal. The cover lies with a peripheral flange on the continuous seal and, within its region surrounded by the continuous seal, has an air passage opening. The water separator is integrated in the cover, and the lower shell, within its region enclosed by the shell seal, carries an air passage opening. By a lower shell being combined with a cover in which the water separator is integrated, the greatest possible freedom is obtained in terms of the arrangement of the air inlet opening in the hood and the access opening of the assembly space and in terms of defining the clear cross section of the air inlet opening in the hood and of the access opening of the assembly space.

The invention is explained in more detail below by means of exemplary embodiments illustrated in the drawing in which, in each case in a diagrammatic illustration.

### BRIEF DESCRIPTION OF THE DRAWINGS

FIG. 1 shows a longitudinal section (y-plane)of an assembly space for a motor vehicle.

FIG. 2 shows a cross section (x-plane) of the assembly space in FIG. 1.

FIG. 3 shows a top view (z-direction) of a hood covering the assembly space in FIGS. 1 and 2, with seals relative to the assembly space.

FIGS. 4 and 5 show two modifications of the assembly space, in each case in the same illustration as in FIG. 1.

FIG. 6 shows a longitudinal section (y-plane) of an assembly space according to a further exemplary embodiment.

FIG. 7 shows a cross section (x-plane) of the assembly space in FIG. 7.

FIG. 8 shows a top view (z-direction) of the seal arrangement between the assembly space and hood in FIGS. 6 and 7.

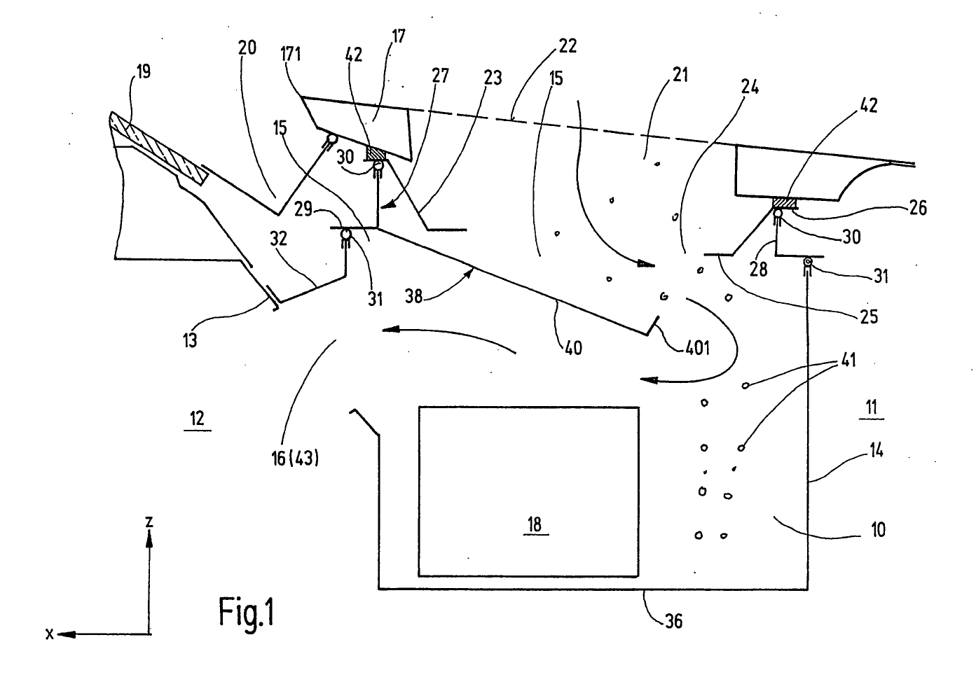

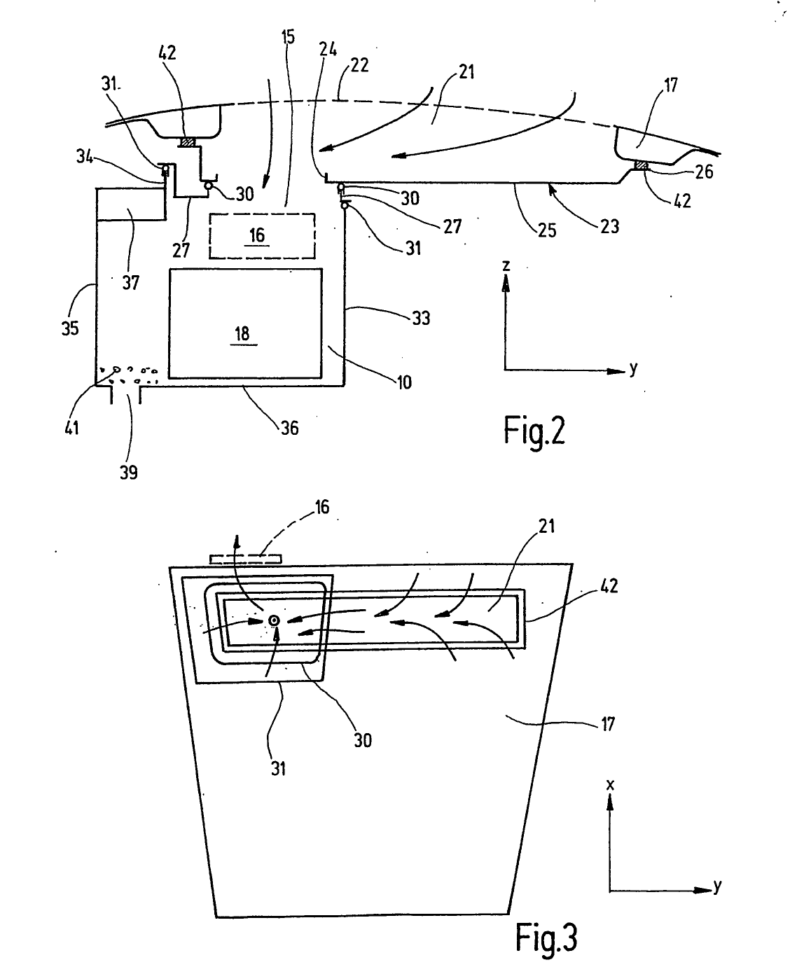

The assembly space 10 is illustrated in FIG. 1 in longitudinal section and in FIG. 2 in a cross section in its arrangement in the forepart of a motor vehicle. The assembly space 10 is delimited relative to a passenger space 12 of a motor vehicle by a dashboard 13 partitioning off the passenger space 12 from an engine space 11 of the motor vehicle and on the opposite side by a partition 14 running transversely in the engine space 11. The two longitudinal sides of the assembly space 10 are formed by additional wall panels 33, 34, 35 (FIG. 2) which are connected to the dashboard 13 and partition 14 and to a bottom 36 in such a way that the assembly space 10 is closed all round with the exception of an upper access opening 15. The dashboard 13 is provided with a dashboard opening 16, to which the suction connection piece of a blower is connected in the usual way. The blower, not illustrated here, may be a simple ventilation blower for ventilating the passenger space 12 or a blower integrated in an air conditioning system for the passenger space 12.

The engine space 11 is covered in a known way by a hood 17. With structural measures yet to be described below, with the hood 17 closed, the assembly space 10 is closed off relative to the engine space 11 in a gastight manner, so that no air can penetrate into the assembly space 10 via the engine space 11. With the hood 17 open, the access opening 15 of the assembly space 10 is exposed, so that the operating assemblies of the motor vehicle, such as a motor vehicle battery 18, which are arranged in the assembly space 10 are freely accessible for mounting, demounting and maintenance. For sake of completeness, the windshield or front window 19 of the motor vehicle and a water collecting channel 20 formed between the front window 19 and the trailing edge 171 of the hood 17 are also indicated on the left in FIG. 1.

In the hood 17, conventionally having a double-walled design with a hood inner panel, there is an air inlet opening 21 which extends at a distance in front of the trailing edge 171 of the hood 17 and parallel to the hood 17, transversely over the hood 17 (FIG. 3). The air inlet opening 21 is covered conventionally with a coarse-mesh grid 22. The air inlet opening 21 is covered by a lower shell 23 which is fastened to the hood inner panel and which is sealed off relative to the underside of the hood 17 by a seal 42 surrounding the air inlet opening 21. In the exemplary embodiment of FIGS. 1 and 2, the lower shell 23 is fastened as a separate component to the underside of the hood 17 and preferably consists of sheet metal. There is, however, also the possibility of adapting the hood inner panel in such a way that it forms the lower shell 23. In this case, a separate component and the seal 42 are dispensed with. The lower shell 23 is of trough-shaped design with a planar trough bottom 25 having an air passage opening 24 and with a flange-like trough edge 26 running peripherally on the trough orifice. Between the lower shell 23 and the assembly space 10 is inserted a cover 27 which has a peripheral collar 28 and a peripheral flange 29 projecting at right angles at one collar end. Plugged onto that end of the collar 28 which is remote from the peripheral flange is a shell seal 30. With the hood 17 closed, the lower shell 23 lies on the shell seal 30 with its trough edge 26, while the peripheral flange 29 of the cover 27 is pressed on a continuous seal 31 which surrounds the access opening 15 of the assembly space 10. As is evident from FIGS. 1 and 2, the continuous seal 31 is placed onto the continuous front edge, pointing towards the hood 17, of the assembly space 10, i.e., directly onto the partition 14, and onto a wall panel 32 fixedly connected to the dashboard 13 and onto the further wall panels 33 or 34, 35 delimiting the assembly space 10 (FIG. 2). The wall panel 35 connects the bottom 36 of the assembly space 10 to a side member 37. The wall panel 34 is fastened to the side member 37 and, on its free front edge pointing away from the side member 37, carries part of the continuous seal 31. The run of the seals 42, 30 and 31 in relation to the air inlet opening 21 arranged in the hood 17 can be seen particularly clearly in FIG. 3.

Integrated in the cover 27 is a water separator 38, at which the air penetrating into the assembly space 10 via the air inlet opening 21 in the hood 17 and via the air passage opening 24 in the lower shell 23 is deflected through more than 90° before it can flow out of the assembly space 10 via the dashboard opening 16 located in the dashboard 13 and forming a waste air opening 43 of the assembly space 10. At the water separator 38, water drops contained in the form of a mist in the air are separated and, as a result of the design of the water separator 38, drop vertically downward onto the bottom 36 of the assembly space 10. A water outflow 39 is provided there at the lowest point. The integrated water separator 38 is formed by an air guide plate 40 which projects from that end of the collar-shaped cover 27. The cover 27 carries the peripheral flange 29 through the access opening 15 into the assembly space 10 and which is oriented obliquely with respect to the vertical axis of the access opening 15. At the free end of the air guide plate 40, an angled web 401 may also be provided, which induces intensified air swirling and promotes the condensation of the mist as water droplets. The web 401 at the same time forms with the air guide plate 40 a water outflow channel 20, by means of which the precipitating water is conducted toward that side of the assembly space 10 on which the water outflow 39 is arranged. The air guide plate 40 is in this case oriented in such a way that it extends over a large part of the access orifice 15, and the waste air opening 43, identical to the dashboard opening 16, of the assembly space 10 lies on the rear side, facing away from the air passage opening 24 in the lower shell 23, of the air guide plate 40. As a result the air is deflected to a maximum and flows around the operating assemblies arranged in the assembly space 10 before it passes via the dashboard opening 16 to the air consumer.

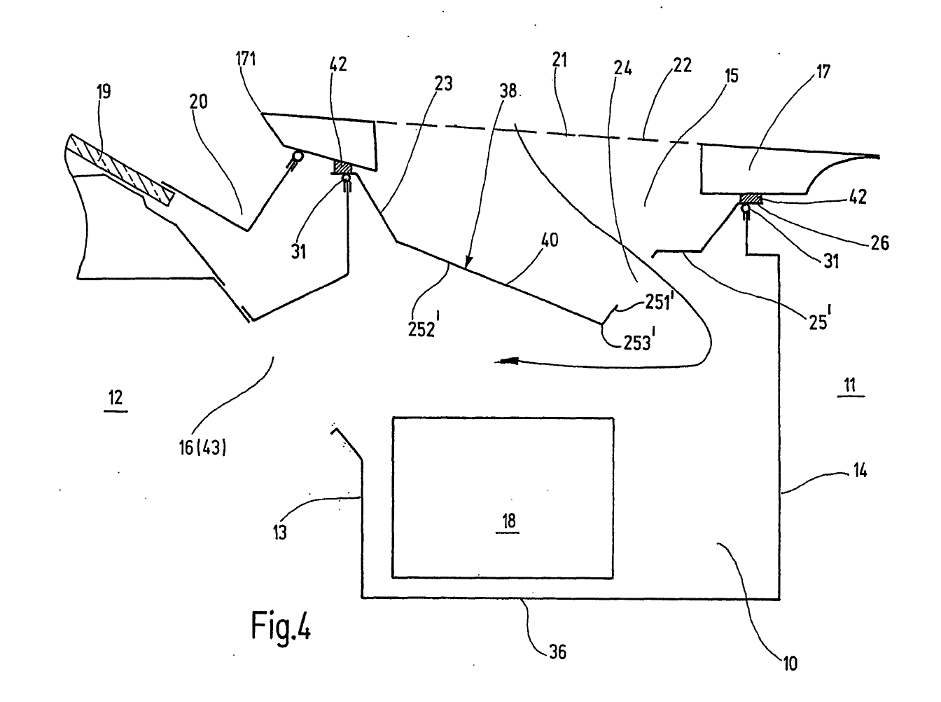

The assembly space 10, illustrated in longitudinal direction in FIG. 4, according to a further exemplary embodiment, is changed with respect to the assembly space 10 described in as much as the cover 27 in FIGS. 1 and 2 is dispensed with and the sealing of the assembly space 10 is carried out directly on the lower shell 23 of the hood 17. Identical components are given the same reference symbols in FIGS. 1 and 4.

As in the exemplary embodiment according to FIG. 1, in the assembly space 10 according to FIG. 4, too, the air inlet opening 21 in the hood 17 is covered by a lower shell 23 which is sealed off, by a seal 42 surrounding the air inlet opening 21, relative to the hood 17 and is fastened to the hood 17. The lower shell 23 again has a trough bottom 25′ and a trough edge 26 surrounding the trough opening in a flange-like manner. When the hood 17 is being closed, the lower shell 23 comes to lie with its trough edge 26 in a gastight manner onto the continuous seal 31 which surrounds the access opening 15 of the assembly space 10. The continuous seal 31 is again placed onto the front edge, facing the hood 17, of the assembly space 10.

The water separator 38 is formed in the lower shell 23 and has an air guide plate 40 which again projects from the lower shell 23 to the access opening 15 and runs obliquely with respect to the axis of the access opening 15. The air guide plate 40 extends at a distance in front of the dashboard opening 16 or of the waste air opening 43 of the assembly space 10, so that the air which passes through the air passage opening 24 in the lower shell 23 has to flow around the air guide plate 40 before it arrives at the dashboard opening 16. To produce the water separator 38, the trough bottom 25′ does not have a planar design, but, instead, projects in the manner of a lean-to roof, with a narrow roof surface 251′ and a wide roof surface 252′ and also an underlying roof ridge 253′, through the access opening 15. The air passage opening 24 is arranged in the narrow roof surface 251′ at some distance from the roof ridge 253′, and the wide roof surface 252′ forms the air guide plate 40.

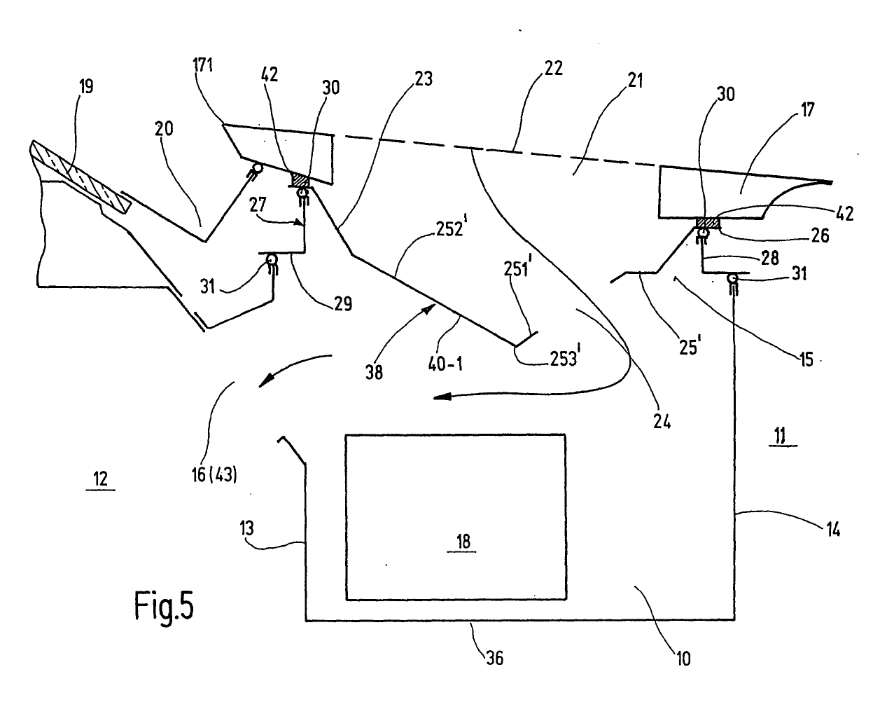

The assembly space 10 of FIG. 5 differs from the assembly space 10 of FIG. 4 only in that, in addition to the lower shell 23 in which the water separator 38 is integrated, a cover 27 is also provided, as was also described with regard to FIG. 1, but here not containing the water separator 38. The again collar-shaped cover 27 with a peripheral collar 28 carries, at one collar edge, the peripheral flange 29 and, at its other free front end, the shell seal 30. With the hood 17 closed, the lower shell 23 is pressed onto the shell seal 30 with its trough edge 26. The trough edge 26 of the lower shell 23 is fastened to the underside of the hood 17 via the seal 42 in the same way. The lower shell 23 containing the water separator 38 is constructed identically to that described with regard to FIG. 4, so that reference is made to this. Identical parts are again given the same reference symbols.

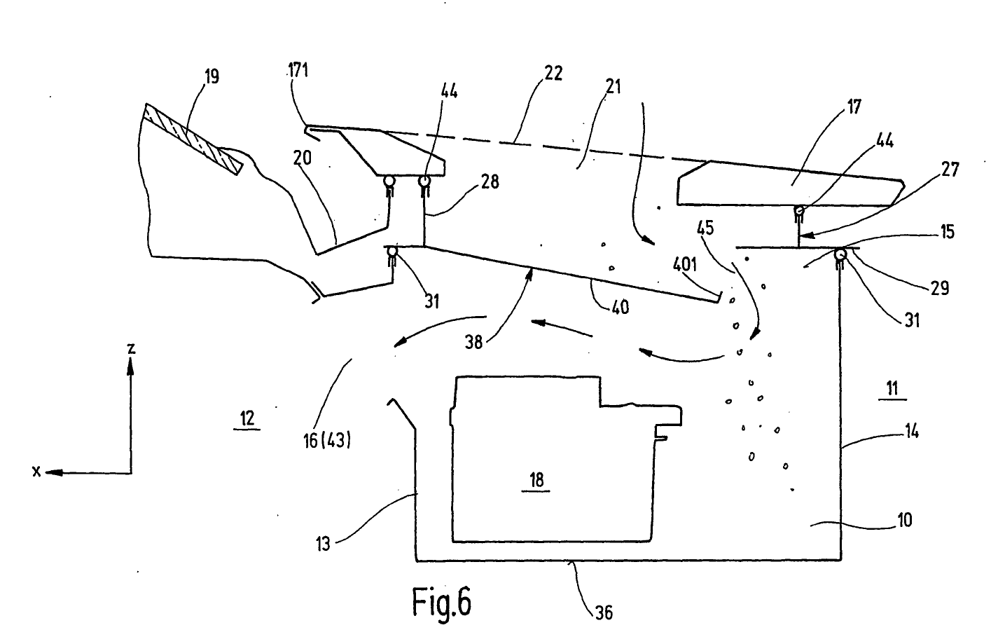

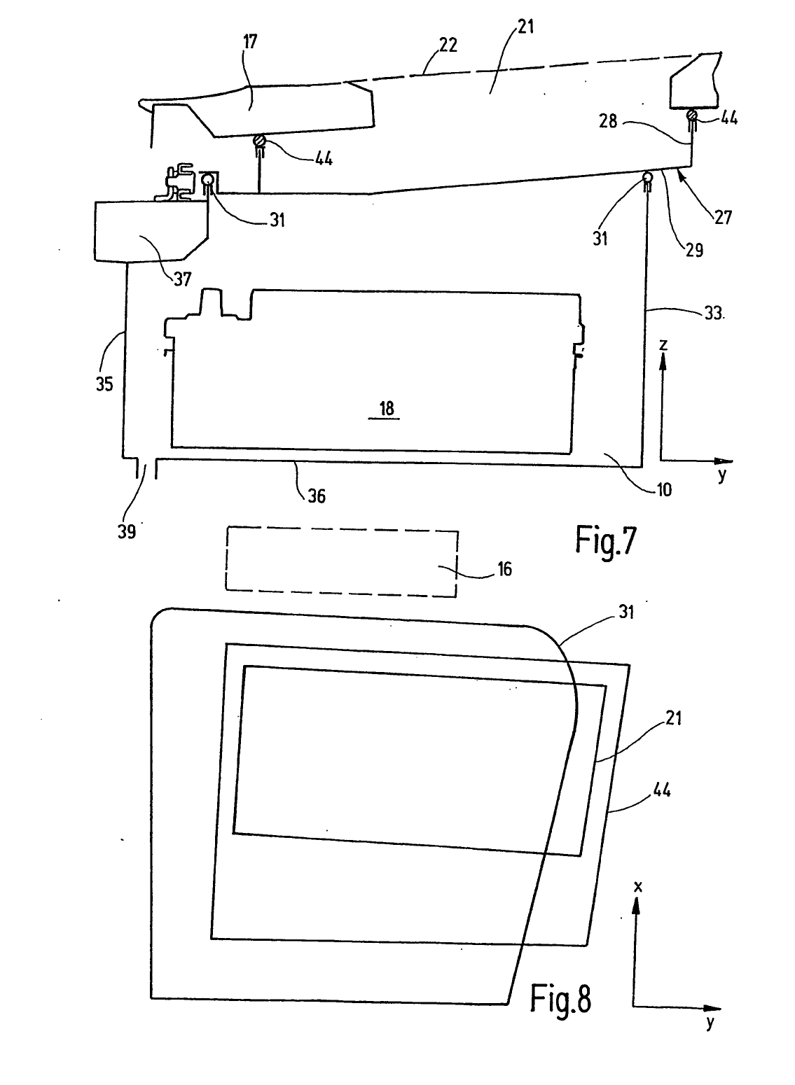

The assembly space 10 outlined in longitudinal section and cross section in FIGS. 6 and 7 differs from the assembly space 10 illustrated in FIG. 1 and described in so far as the lower shell 23 is dispensed with and the cover 27 of the assembly space 10 is sealed off directly on the underside of the hood 17. Identical components are therefore again given the same reference symbols. The cover 27 designed as collar 28 with a peripheral flange 29 again lies with its peripheral flange 29 on the continuous seal 31 surrounding the access opening 15 of the assembly space 10 and, at its front end remote from the peripheral flange, carries a hood seal 44 onto which the closed hood 17 is pressed with its underside. The cover 27 thus covering the access opening 15 has an air passage opening 45 and a water separator 38. For this purpose, an air guide plate 40 is cut out from a covering surface spanning the clear opening within the collar 28 and is bent out of the covering surface in such a way that it projects through the access opening 15 and runs obliquely with respect to the axis of the access opening 15. This results at the free edge of the air guide plate 40, toward the lower front edge of the collar 28, in the formation of an air passage opening 45 which lies on the front side, facing away from the dashboard opening 16, of the air guide plate 40, so that the air flowing into the assembly space 10 via the air inlet opening 21 in the hood 17 and via the air passage opening 45 is deflected through somewhat less than 180° and, on the rear side of the air guide plate 40, flows to the dashboard orifice 16 forming the waste air opening 43 of the assembly space 10 and at the same time washes around the operating assemblies within the assembly space 10. At the leading edge of the air guide plate 40, which may likewise be provided with a web 401, the water droplets in the form of a mist which are precipitated on the air guide plate 40 from the moist air drop down as condensation water drops to the bottom 36 of the assembly space 10.

It is also possible to design the assembly space 10 as a separate plastic box open at the top which is mounted between the dashboard 13 and partition 14. The outflow opening 43 is then arranged in the box wall bearing against the dashboard 13, in such a way that said outflow opening is congruent with the dashboard opening 16. The box bottom has introduced in it, at a somewhat lower point, the water outflow 39 which may be designed as a simple hole or as an outwardly projecting connection piece.

1.-15. (canceled)

16. An assembly space of a motor vehicle for receiving operating assemblies, the motor vehicle including a dashboard, a passenger space, an engine space, and a hood designed to cover the engine space, wherein the dashboard separates the passenger space from the engine space, the assembly space comprising:
an access opening pointing towards the hood, wherein the assembly space is mounted in front of the dashboard and is closed all round with the exception of the access opening;
a continuous seal surrounding the access opening all round for gastight sealing relative to the engine space;
an incoming air connection to an air inlet opening arranged in the hood,
a waste air opening which is approximately congruent with a dashboard opening serving as an intake opening of an air consumer in the passenger space;
a water separator; and
a lower shell which covers the air inlet opening and is sealed off relative to the hood and which is disposable onto the continuous seal and, within its region surrounded by the continuous seal, has an air passage opening, wherein the water separator is formed on the lower shell.

17. The assembly space of claim 16, wherein the lower shell is fastened to the underside of the hood.

18. The assembly space of claim 17, wherein the lower shell is fastened to the underside of the hood in one piece with a hood inner panel.

19. The assembly space of claim 17, wherein the water separator has an air guide plate, which projects from the lower shell through the access opening and runs obliquely with respect to the axis of the access opening, and which extends below part of the access opening, and wherein the waste air opening lies near the access opening, behind the rear side, facing away from the air passage opening, of the air guide plate.

20. The assembly space of claim 19, wherein the lower shell has a trough-shaped design with an opening and a trough bottom and with a flange-like trough edge surrounding the trough opening, for lying on the continuous seal.

21. The assembly space of claim 20, wherein the trough bottom projects in the manner of a lean-to roof having a narrow and a wide roof surface and an underlying roof ridge, through the access opening, wherein the air passage opening is arranged at a distance from the roof ridge in the narrow roof surface, and wherein the wide roof surface forms the air guide plate.

22. The assembly space of claim 21, further comprising a cover that has a peripheral collar and a peripheral flange arranged at one end of the collar and that is arranged between the access opening and the lower shell, wherein the cover lies with its peripheral flange on the continuous seal and, on its collar edge remote from the flange, carries a shell seal, onto which the lower shell can be pressed.

23. The assembly space of claim 22, further comprising a space bottom and space walls which project from the space bottom and of which one space wall is formed by the dashboard and the opposite space wall is formed by a partition, running transversely in the engine space, for partitioning off the engine space.

24. The assembly space of claim 22, comprising a plastic box closed on all sides and open at the top.

25. The assembly space of claim 24, wherein a water outflow is provided in the space bottom.

26. The assembly space of claim 23, wherein a water outflow is provided in the space bottom.

27. An assembly space of a motor vehicle for receiving operating assemblies, the motor vehicle including a dashboard, a passenger space, an engine space, and a hood designed to cover the engine space, wherein the dashboard separates the passenger space from the engine space, the assembly space comprising:
an access opening pointing towards the hood, wherein the assembly space is mounted in front of the dashboard and is closed all round with the exception of the access opening;
a continuous seal surrounding the access opening all round for gastight sealing relative to the engine space;
an incoming air connection to an air inlet opening arranged in the hood,
a waste air opening which is approximately congruent with a dashboard opening serving as an intake opening of an air consumer in the passenger space;
a water separator; and
a cover which covers the air inlet opening and which lies on the continuous seal, wherein the cover can be sealed off relative to the hood by means of a continuous hood seal surrounding the air inlet orifice and, within its region surrounded by the continuous seal, has an air passage opening, and wherein the water separator is integrated in the cover.

28. An assembly space of a motor vehicle for receiving operating assemblies, the motor vehicle including a dashboard, a passenger space, an engine space, and a hood designed to cover the engine space, wherein the dashboard separates the passenger space from the engine space, the assembly space comprising:
an access opening pointing towards the hood, wherein the assembly space is mounted in front of the dashboard and is closed all round with the exception of the access opening;
a continuous seal surrounding the access opening all round for gastight sealing relative to the engine space;
an incoming air connection to an air inlet opening arranged in the hood,
a waste air opening which is approximately congruent with a dashboard opening serving as an intake opening of an air consumer in the passenger space;
a water separator;
a lower shell which covers the air inlet opening and is sealed off relative to the hood; and
a cover which can be sealed off relative to the lower shell by a shell seal and which lies on the continuous seal, wherein the water separator is integrated in the cover, and wherein the lower shell, within its region enclosed by the shell seal, has an air passage opening.

29. The assembly space of claim 28, wherein the lower shell is fastened to the underside of the hood and the shell seal is secured to the cover.

30. The assembly space of claim 29, wherein the lower shell has a trough-shaped design with a planar trough bottom and a trough edge surrounding a trough opening in a flange-like manner, for lying on the shell seal, and wherein the air passage opening is arranged in the trough bottom.

31. The assembly space of claim 30, wherein the cover has a peripheral collar and a peripheral flange arranged at one collar edge, and wherein the cover lies with its peripheral flange on the continuous seal and at its collar end remote from the flange carries the shell seal.

32. The assembly space of claim 31, wherein the water separator has an air guide plate which projects from the cover through the access opening and runs obliquely with respect to the axis of the access opening and which extends below a part of the access opening, and wherein the waste air opening lies near the access opening, behind the rear side, facing away from the air passage opening, of the air guide plate.

33. The assembly space of claim 32, further comprising a space bottom and space walls which project from the space bottom and of which one space wall is formed by the dashboard and the opposite space wall is formed by a partition, running transversely in the engine space, for partitioning off the engine space.

34. The assembly space of claim 33, comprising a plastic box closed on all sides and open at the top.

35. The assembly space of claim 34, wherein a water outflow is provided in the bottom of the plastic box.
